(19) United States
(12) Patent Application Publication
(10) Pub. No.: US 2026/0199936 A1
(43) Pub. Date: Jul. 16, 2026

(54) VIBRATORY MATERIAL SCREENS AND METHODS FOR THEIR USE

(71) Applicant: Univation Technologies, LLC, Houston, TX (US)

(72) Inventors: Marc S. Black, Midland, MI (US); Prashant Sharad Shembekar, Maharashtra (IN)

(73) Assignee: Univation Technologies, LLC, Houston, TX (US)

(21) Appl. No.: 19/135,662

(22) PCT Filed: Dec. 5, 2023
(86) PCT No.: PCT/US2023/082514

§ 371 Date: Jun. 4, 2025

(30) Foreign Application Priority Data
Dec. 7, 2022 (IN) 202241070555

(51) Int. Cl. B07B 1/46; B07B 1/28

(52) U.S. Cl. CPC B07B 1/4654; B07B 1/28

(57) ABSTRACT

Embodiments of the present disclosure are directed to screens (110) and vibratory particle screeners (100) including those screens (110), wherein the screens (110) include: a screen frame comprising a pair of opposing latitudinal edges (119) and a pair of opposing longitudinal edges (117), wherein the pair of opposing latitudinal edges (119) and the pair of opposing longitudinal edges (117) define a horizontal plane; a plurality of wires (125) extending horizontally between the pair of opposing longitudinal edges, wherein the wires (125) comprise wavy vertical profiles relative to the horizontal plane, and wherein adjacent wires (111, 112) have differing wavy vertical profiles.

### CROSS-REFERENCE TO RELATED APPLICATIONS

This application claims the benefit of India Patent Application No. 202241070555 filed Dec. 7, 2022, the entire disclosure of which is hereby incorporated herein by reference.

### TECHNICAL FIELD

Embodiments of the present disclosure generally relate to vibratory material screens and methods for their use. More specifically, embodiments of the present disclosure relate to apparatuses for vibratory material screens that provide improved separation of material comprising a screen with longitudinal wires

### BACKGROUND

In the processing of polymers, the separation of material is an important step to ensure high yield of components such as Polyethylene in the form of beads, granules, pellets, powders, and resins. Particle screeners are one way to achieve such separation, but current vibratory screens are primarily engineered for industrial mining applications with longitudinal and latitudinal wires welded to a frame. This design often results in screen clogging for smaller material separations, such as the aforementioned polymer applications. Accordingly, an ongoing need exist for screens used in vibratory particle screeners that achieve higher yield of component separation without screen clogging.

### SUMMARY

Embodiments of the present disclosure address these needs by utilizing a screen comprising a plurality of wires with a screen having a wavy vertical profile. This screen may also be considered to have a wavy-out-of-phase (WOOP) profile, which imparts a tumbling motion to the particles it is sorting such the particles may reorient themselves to allow them to pass through the screen.

According to at least one aspect of the present disclosure, a screen frame includes a pair of opposing latitudinal edges and a pair of opposing longitudinal edges, wherein the pair of opposing latitudinal edges and the pair of opposing longitudinal edges define a horizontal plane and a plurality of wires extending horizontally between the pair of opposing longitudinal edges, wherein the wires comprise wavy vertical profiles relative to the horizontal plane, and wherein adjacent wires have differing wavy vertical profiles.

According to one or more other aspects, a vibratory particle screen may include a screen frame with a pair of opposing latitudinal edges and a pair of opposing longitudinal edges, wherein the pair of opposing latitudinal edges and the pair of opposing longitudinal define a horizontal plane and a plurality of wires extending horizontally between the pair of opposing longitudinal edges, wherein the wires comprise wavy vertical profiles relative to the horizontal plane, and wherein adjacent wires have differing wavy vertical profiles.

According to one or more other aspects, a method of filtering out off-spec material from a particle mixture using the vibratory particle screener that may include a screen frame with a pair of opposing latitudinal edges and a pair of opposing longitudinal edges, wherein the pair of opposing latitudinal edges and the pair of opposing longitudinal edges define a horizontal plane and a plurality of wires extending horizontally between the pair of opposing longitudinal edges, wherein the wires comprise wavy vertical profiles relative to the horizontal plane, and wherein adjacent wires have differing wavy vertical profiles.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a schematic diagram of a side view of two wires within a vibratory particle screener having a WOOP profile, according to one or more embodiments described in this disclosure;

FIG. 2 depicts a schematic diagram of a top view of two wires within the WOOP screen, according to one or more embodiments described in this disclosure;

FIG. 3 depicts a generalized schematic diagram of an isometric view of a vibratory particle screener having a WOOP screen, according to one or more embodiments described in this disclosure

FIG. 4 depicts a generalized schematic diagram of an arrangement of a plurality of wires within a WOOP screen, according to one or more embodiments described in this disclosure;

FIG. 5 depicts a chart of the various general shapes of Polyethylene particles to be sorted by a vibratory particle screener, according to one or more embodiments described in this disclosure;

FIG. 6A depicts a Finite Element Analysis (FEA) model of an arrangement of Polyethylene particles to be sorted by a cross-wire vibratory particle screener;

FIG. 6B depicts an FEA model of a plurality of Polyethylene particles after 1 second of vibration time of a cross-wire vibratory particle screener;

FIG. 7A depicts a Finite Element Analysis (FEA) model of an arrangement of Polyethylene particles to be sorted by a unidirectional vibratory particle screener;

FIG. 7B depicts an FEA model of a plurality of Polyethylene particles after 1 second of vibration time of a unidirectional vibratory particle screener;

FIG. 7B illustrates an aspect of the subject matter in accordance with one embodiment;

FIG. 8 depicts an FEA model of an arrangement of Polyethylene particles to be sorted by a unidirectional vibratory particle screener;

FIG. 9 depicts a top view of an FEA model of a plurality of Polyethylene particles after 1 second of vibration time of a unidirectional vibratory particle screener;

FIG. 10A depicts a top view of an FEA model of a plurality of Polyethylene particles after 1 second of vibration time of a WOOP vibratory particle screener;

FIG. 10B illustrates an isometric view of an FEA model of a plurality of Polyethylene particles after 1 second of vibration time of a WOOP vibratory particle screener.

### DETAILED DESCRIPTION

The present disclosure is directed to apparatuses and methods for separating off-spec particles from the desired product, such as Polyethylene, for example. According to at least one aspect of the present disclosure, a screen frame includes a pair of opposing latitudinal edges and a pair of opposing longitudinal edges, wherein the pair of opposing latitudinal edges and the pair of opposing longitudinal edges define a horizontal plane and a plurality of wires extending horizontally between the pair of opposing longitudinal edges, wherein the wires comprise wavy vertical profiles relative to the horizontal plane, and wherein adjacent wires have differing wavy vertical profiles.

The apparatuses and methods of the present disclosure may enable polyolefin particles to be selected from Polyethylene or polypropylene by filtering out off-spec particles from a particle mixture using a vibratory particle screener, wherein the off-spec material are larger particles blocked by the screen. Further, the vibratory particle screener may include a housing comprising at least one accept bin and at least one reject bin, wherein the accept bin is oriented to receive particles that pass through the screen and the reject bin is oriented to receive particles filtered out by the screen.

As used in this disclosure, “out of phase” refers to adjacent wires having different curvatures in the vertical direction.

As used in this disclosure, “blinding” refers to the screen clogging of the vibratory screen. Screen blinding occurs when the screen mesh openings become blocked or clogged by the material being screened. Once particles become trapped or particles build up on the screen surface, this prevents the screen openings from allowing material to pass or it severely restricts the passage of finer powders.

The term “polymer” refers to a polymeric compound prepared by polymerizing monomers, whether of a same or a different type. The generic term polymer thus embraces the term “homopolymer,” which usually refers to a polymer prepared from only one type of monomer as well as “copolymer,” which refers to a polymer prepared from two or more different monomers. The term “interpolymer,” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used in this disclosure, “off-spec” refers to particles that do not meet the required specifications. In some instances, “off-spec” may refer to particles having one or more dimensions larger than the product specifications.

As used in this disclosure, “cross-wire” refers to a conventional screen design that is a mesh. The mesh includes longitudinal and latitudinal wires that may be placed evenly apart such that an area is open for material to fall through. This mesh is oscillated to sift the incoming material. As the material is transported down the inclined mesh face, the material pieces smaller than the openings fall through, while material larger than opening is directed to an oversize chute at the end of the device.

As used in this disclosure, “unidirectional” refers to a screen design that consists of unidirectional wires. That is to say that the screen comprises straight, longitudinal wires. The screen does not comprise any latitudinal cross wires, and there are not any undulations in the wires. This mesh is oscillated to sift the incoming material. As the material is transported down the inclined mesh face, the material pieces smaller than the spaces between the longitudinal wires fall through, while material larger than opening is directed to an oversize chute at the end of the device.

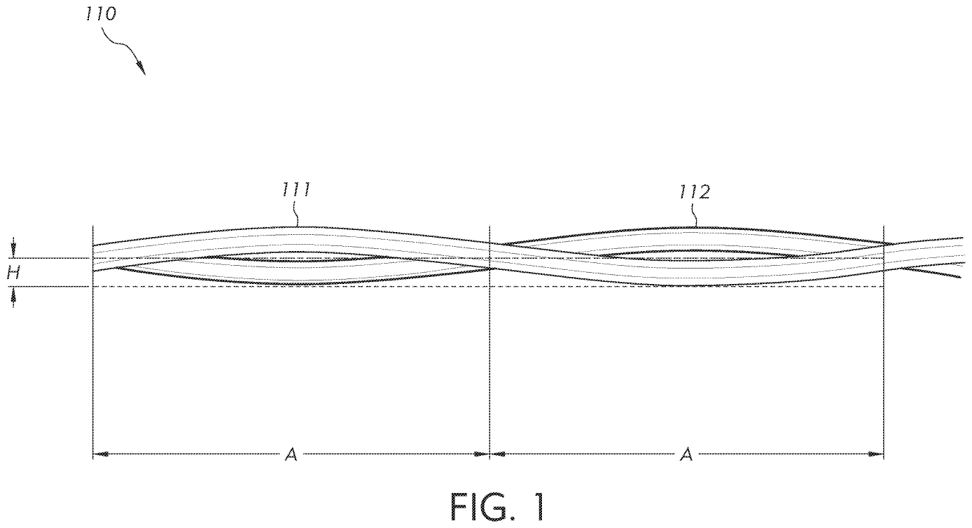

Referring now to the embodiment of FIG. 1, a side view of two wires within the WOOP screen 110 are schematically depicted. A first wire 111 is shown next to a second wire 112. Both the first wire 111 and the second wire 112 have an amplitude with an absolute value of H and a period of 2 A. In some embodiments, the first wire 111 and the second wire 112 may be a pair of wavy-out-of-phase wires that repeat for as many wires that comprise the plurality of wires 125 within the WOOP screen 110 such that each wire within the plurality of wires has an amplitude with an absolute value of H and a period of 2 A. In this embodiment, the vertical wavy profile of the WOOP screen 110 is such that adjacent wires within the plurality of wires 125 have sinusoidal profiles out of phase relative to one another. In other embodiments, it is contemplated that adjacent wires within the plurality of wires 125 may have respective profiles that are nonuniform and random. That is to say, the plurality of wires 125 may comprise wires that have no ordered sinusoidal profiles relative to the profile of other wires.

The WOOP screen 110 may have an amplitude with an absolute value between 5 mm and 10 mm. Referring to FIG. 1 as an example, the value of the amplitude (H) may be between 6 mm and 10 mm, 7 mm and 10 mm, 8 mm and 10 mm, or even 9 mm and 10 mm. The WOOP screen 110 may also have a period between 100 mm and 300 mm. For example, still referring to FIG. 1, the value of the period (2 A) may be between 125 mm and 300 mm, 150 mm and 300 mm, 175 mm and 300 mm, 200 mm and 300 mm, 225 mm and 300 mm, 250 mm and 300 mm, or even 275 mm and 300 mm.

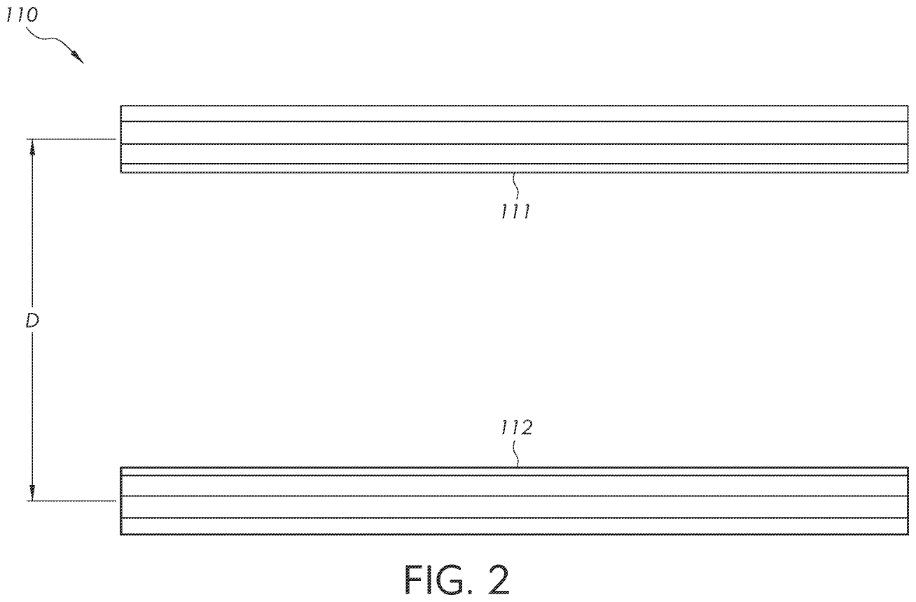

Referring now to the embodiment of FIG. 2, a top view of the first wire 111 and the second wire 112 is schematically shown within the WOOP screen 110. The first wire 111 and the second wire 112 are a distance apart, D. In this embodiment, the first wire 111 and the second wire 112 may be a pair of wavy-out-of-phase wires that repeat for as many wires that comprise the plurality of wires 125 within the WOOP screen 110 such that there is horizontal spacing of a distance D between each of the plurality of wires. It is contemplated that in other embodiments, the horizontal spacing between each of the plurality of wires 125 may be nonuniform and random, and varied distances are contemplated.

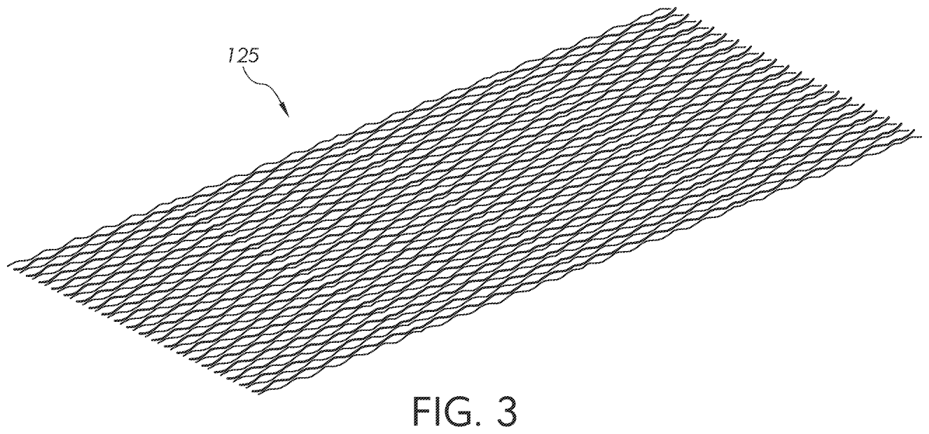

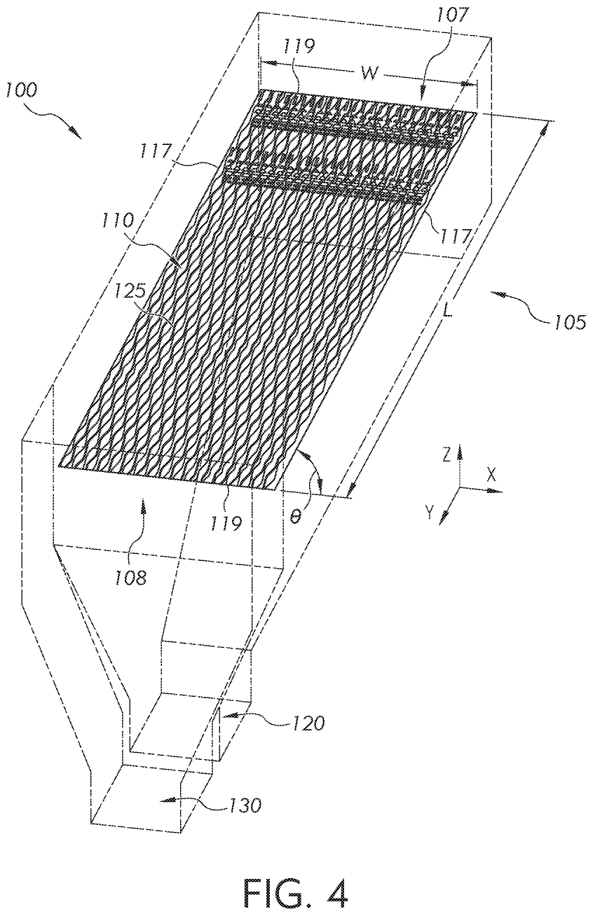

Referring now to the embodiment of FIG. 3, an arrangement of wires within the WOOP screen 110 is schematically shown. In this embodiment, the plurality of wires 125 may have an undulating vertical profile running down their length and an amplitude with an absolute value of H (not shown). In this embodiment, each wire alternates the undulation pattern with a period of 2 A (not shown), as depicted in FIG. 4. Various materials are considered suitable for the WOOP screen 110 and the components therein. For Example, the plurality of wires 125 may be stainless steel. For example and not by way of limitation, the plurality of wires 125 may be 304 stainless steel.

Referring now to FIG. 4, a vibratory particle screener system 100 is schematically depicted that includes the above described wavy-out-of-phase (WOOP) screens 110. The WOOP screen includes a screen frame comprising a pair of opposing latitudinal edges 119, having a width W, and a pair of opposing longitudinal edges 117, having a length L, wherein the pair of opposing latitudinal edges 119 and the pair of opposing longitudinal edges 117 define a horizontal plane. The WOOP screen 110 comprises a plurality of wires 125 extending horizontally between the pair of opposing longitudinal edges 117, wherein the plurality of wires 125 comprise wavy vertical profiles relative to the horizontal plane, and wherein adjacent wires have differing wavy vertical profiles.

The WOOP screen 110 may be agitated by an oscillation actuator (not depicted) such that the WOOP screen 110 vibrates. In some embodiments, the WOOP screen may be oriented at an angle theta (0). The WOOP screen 110 may be oriented at angle theta (0) such that the WOOP screen 110 has a top 107 and a bottom 108. The vibratory particle screener system 100 is housed within a housing 105 for the WOOP screen 110 and other components, such as the oscillation actuator (not depicted). For example and not by way of limitation, the vibratory particle screener system 100 may comprise a commercially available housing 105, such as a Derrick® Model SGX48-144D-3 Particle Screener.

The housing 105 also contains an accept bin 120 and a reject bin 130. The acceptable or good quality particles can fall in the entire region below the screen to the accept zone 120, whereas particles that do not get filtered and reach the end of screen fall into a reject zone 130. Particles that blind the screen do not fall into either zone. It is possible that good or acceptable particles do not find an opening in the screen and due to high velocity, they fall into the reject zone 130, reducing the productivity of the machine. If large area of the screen is blinded, the productivity of the screen gets significantly reduced.

### EXAMPLES

The various aspects of the present disclosure will be further clarified by the following examples. The examples are illustrative in nature and should not be understood to limit the subject matter of the present disclosure.

### Comparative Examples 1 and 2

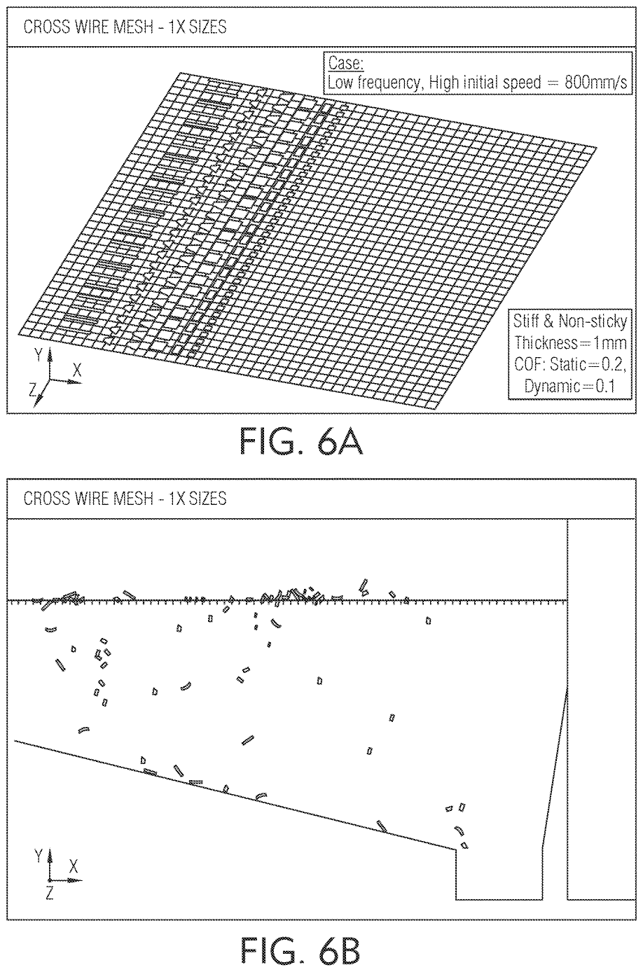

In Comparative Example 1, a conventional cross-wire screen design was evaluated for blinding and rejection of good Polyethylene particles using Finite Element Analysis (FEA). FIG. 6A depicts Comparative Example 1 before the particles acquire initial velocity due to gravity and the vibration is commenced. FIG. 6B depicts Comparative Example 1 at time equals 1.4 seconds, where various Polyethylene particles have been blinded, accepted, or rejected.

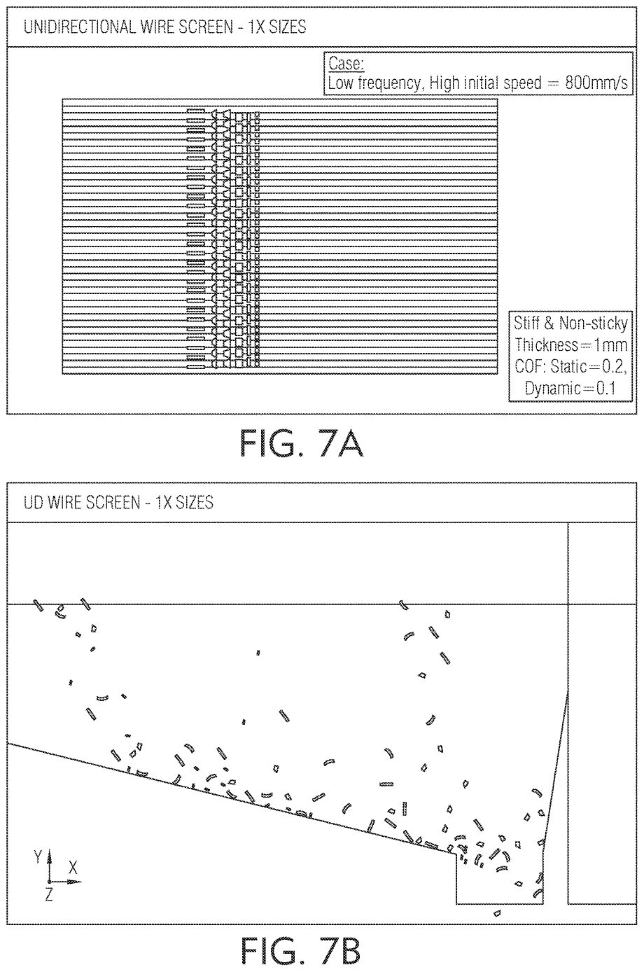

In Comparative Example 2, a unidirectional mesh screen design was evaluated for blinding and rejection of good Polyethylene particles using FEA. FIG. 7A depicts Comparative Example 2 before the particles acquire initial velocity due to gravity and the vibration is commenced. FIG. 7B depicts Comparative Example 2 at time equals 1.16 seconds, where various Polyethylene particles have been blinded, accepted, or rejected.

Several types of commercial FEA software are available that can be used to perform such analysis. The results listed in the present disclosure were obtained using LS-DYNA®, which is an advanced general-purpose multiphysics simulation software. The FEA incorporates 3D mesh models of the screen, frame supporting the screen, container that encloses the screen, and the particles that are screened. The scope of the FEA model herein is restricted to study the effect of screen geometry on filtering performance, which allows simplifications in terms of structural connections.

The FEA models of each particle screen design incorporated many variables, including a full size screen model of 4.6 meters by 1.2 meters. The wire mesh details of the cross-wire were analyzed in 3D with a wire diameter of 6 millimeters. In addition, the screen vibration, including amplitude and frequency, was controlled, along with the screen angle. Gravity was considered. The FEA model also took into account friction between Polyethylene particles and friction between Polyethylene particles and the vibratory screen. Polyethylene particle thickness and modulus at high temperatures were also considered.

The FEA Models for Comparative Examples 1 and 2 utilized the following material properties for the polyethylene particles: a density of 1.0E−09 ton/mm³, elastic modulus of 2500 MPa, yield stress of 80 MPa, and Poisson's ratio of 0.3. The polyethylene particles were modeled shell elements at 1 mm thick. The material model (*MAT_PIECEWISE_LINEAR_PLASTICITY) was used to define the Elastic-Plastic behaviour of the PE particles. The screen made of steel wires was modelled with solid element with a typical wire diameter of 6 mm. The average element size was 1 mm. Linear elastic material model (*MAT_ELASTIC) was used for the screen and typical elastic properties of steel. The frame supporting the screen was modeled with shell elements. The frame was rigidly fixed and material model (*MAT_RIGID) was used for the same. Similarly, the container was also rigidly fixed and material model (*MAT_RIGID) was used.

The particles were dropped on the screen on one end at a higher elevation. All polyethylene particles were given certain initial velocity to incorporate the effect of the drop. The screen was inclined at an angle that allowed the particles to fall through the openings while sliding down under gravity. In the model, the screen was kept horizontal (e.g., parallel to the X-direction). The effect of screen angle was introduced by providing the appropriate component of gravity in both the horizontal (X) and vertical (Y) directions to polyethylene particles as seen in FIG. 4. The typical screen inclination was 30° with respect to the horizontal direction (ground). Gravity in both the X and Y directions was applied to the set of polyethylene components using the *LOAD_GRAVITY_PART_SET card in LS-DYNA®.

In addition to the gravitation acceleration, the polyethylene particles were also provided initial velocity using *INITIAL_VELOCITY card in LS-DYNA®. The initial velocity provided to polyethylene shell particles was 400 mm/s in X-direction. The actual velocity of PE particles in production may be much higher and is not limited by this disclosure. The shell particles were not provided with initial velocity in Y-direction. The vertical downward velocity was acquired by the shell particles due to vertical component gravitational acceleration. While the bulk of the material is thin (1 mm thick), the blinding of screen usually occurs due to thick particles.

The screen was supported on frame by defining contact between them using *CONTACT_AUTOMATIC_SURFACE_TO_SURFACE_SMOOTH_ID. The screen was also kept under tension by stretching each steel wire using the card *BOUNDARY_PRESCRIBED_MOTION_SET_ID. The stretch of 10 mm was applied to each wire in horizontal direction. This prevented the wires from undue swing when the particles hit the wires. The screen edges were also constrained to move only in horizontal (X-Z) plane by applying boundary conditions using card *BOUNDARY_SPC_SET preventing other degrees of freedom.

The polyethylene thin shell particles were positioned on a platform before they were pushed onto the screen. The platform was modelled with the shell element and assigned a rigid fixed material. The contacts of screen wires, container, and platform with PE particles were defined using *CONTACT_AUTOMATIC_SURFACE_TO_SURFACE_SMOOTH_ID card. The contact between PE particles themselves were defined using *CONTACT_AUTOMATIC_SINGLE_SURFACE_SMOOTH_ID card. The static coefficient of friction (COF) of 0.2 and dynamic coefficient of friction of 0.1 were defined in the contacts.

The vibration of screen may be modelled using card *BOUNDARY_PRESCRIBED_MOTION_SET_ID in association with a cyclic amplitude curve. Further, frequency of vibration may also be changed by use of different amplitude curves. However, the results presented in all the cases do not incorporate the effect of vibration of the screen to identify the effect of screen geometry alone on the screening efficiency. Polyethylene particles that fall on the screen are at a high temperature. The sticky behavior of the polyethylene particles due to high temperature may be incorporated using COF=1.0. To identify the effect of screen geometry on the screening efficiency, sticky behavior of PE particles was not incorporated in the contact definitions.

Polyethylene shell particles require about five seconds for all the particles to reach the end of screen. Due to the large size of the model, typically the computational time for each run is about 75 hours with 8 SMP threads (8 CPU).

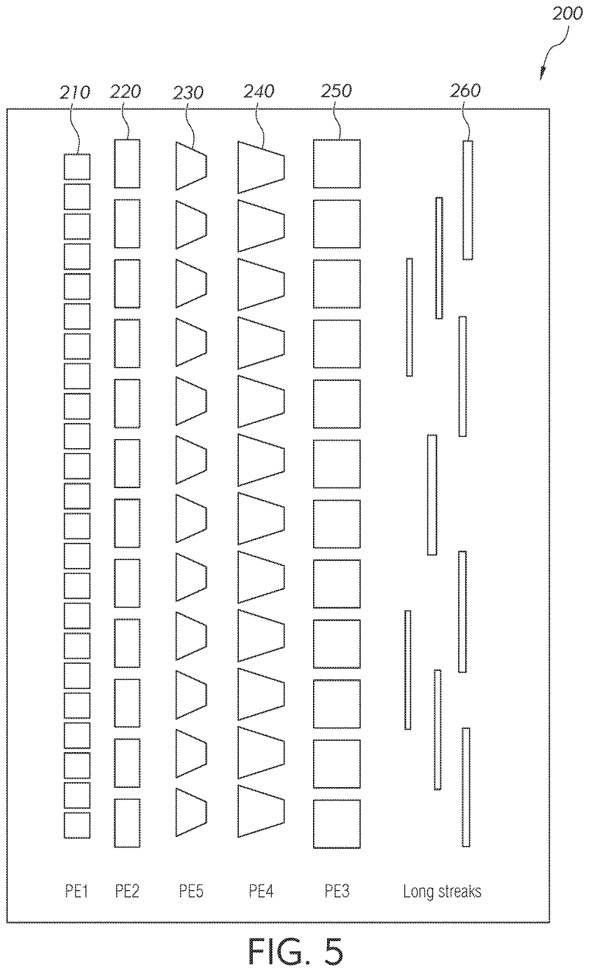

A variety of thin particle shapes and sizes were considered for the performance evaluations. Table 1 below lists the various shapes and sizes of Polyethylene particles, each with a thickness of 1 mm. Referring now to FIG. 5, a general arrangement of various Polyethylene particles 200 is schematically shown. The various Polyethylene particles 200 include square Polyethylene particles 210, rectangle Polyethylene particles 220, larger rectangle Polyethylene particles 250, wedge Polyethylene particles 240, smaller wedge Polyethylene particles 230, and long streaks 260.

TABLE 1

| Particle | Size (mm) |
|---|---|
| PE1 (Square) | 20 × 20 |
| PE2 (Rectangle) | 40 × 20 |
| PE3 (Rectangle) | 40 × 40 |
| PE4 (Wedge) | 40 × 20 × 37 |
| PE4 (Wedge) | 40 × 16 × 25 |
| Long Streaks | 5 × 100 |

### Example 1

In Example 1, a WOOP screen design was evaluated for blinding and rejection of good Polyethylene particles using FEA for comparison with a cross-wire screen of Comparative Example 1 and a unidirectional screen of Comparative Example 2. The particles sizes were the same as those used in Comparative Examples 1 and 2. Table 1 above lists the various shapes and sizes of Polyethylene particles, each with a thickness of 1 mm. FIG. 5 depicts the general shape of the various Polyethylene particles with 2D examples of the Polyethylene particles listed in Table 1 may be seen. FIG. 1 depicts an embodiment applicable to Example 1 within the WOOP screen system 110.

The FEA model for Example 1 utilized the same parameter data as Comparative Examples 1 and 2 with the exception of changing the screen geometry.

### Comparison of Comparative Examples 1 and 2 to Example 1

Comparative Examples 1 and 2 and Example 1 will now be compared for both the tendency of blinding to occur with various sized Polyethylene particles in addition to the rejection rate of the Polyethylene particles. Table 2 below shows the number of Polyethylene particles accepted and the number of Polyethylene particles rejected for each iteration run by the FEA model for the cross-wire screen, the unidirectional screen, and the WOOP screen.

TABLE 2

| | Comparative | | Comparative | | | |
|---|---|---|---|---|---|---|
| Particle Size, | Example 1 | | Example 2 | | Example 2 | |
| (mm × mm) | (Cross-Wire | | (Unidirectional | | (WOOP Screen) | |
| Thickness = 1 | Accept | Reject | Accept | Reject | Accept | Reject |
| PE1 - 20 × 20 | 4 | 19 | 23 | 0 | 23 | 0 |
| PE2 - 40 × 20 | 0 | 12 | 12 | 0 | 12 | 0 |
| PE3 - 40 × 40 | 0 | 12 | 9 | 3 | 12 | 0 |
| PE4 - 40 × 20 | 0 | 12 | 12 | 0 | 12 | 0 |
| PE5 - 40 × 16 | 0 | 13 | 13 | 0 | 13 | 0 |
| Long Streaks - | 0 | 9 | 0 | 9 | 0 | 9 |
| Total | 4 | 77 | 69 | 12 | 72 | 9 |

| | | | |
|---|---|---|---|
| Blinded | 15 | 0 | 0 |
| Acceptance | 5% | 85.2% | 88.9% |

As seen in Table 2 above, the cross-wire screen system of Comparative Example 1 had a 5% acceptance rate after all iterations of the FEA model were run, for a total of 81 example particles. The unidirectional screen system of Comparative Example 2 had an 85.2% acceptance rate after all iterations of the FEA model were run, for a total of 81 example particles. However, the WOOP screen system of Example 1 showed an acceptance rate of 88.9% with the same number of particles of the same shape as both the cross-wire and unidirectional screen systems.

Additionally, the cross-wire screen of Comparative Example 1 showed blinding, with 15 of 81 particles blocking the screen. Neither the unidirectional nor the WOOP screen systems experienced any blinding.

### Comparative Example 3

In Comparative Example 3, a unidirectional mesh screen design was evaluated for blinding and rejection of good Polyethylene particles using FEA.

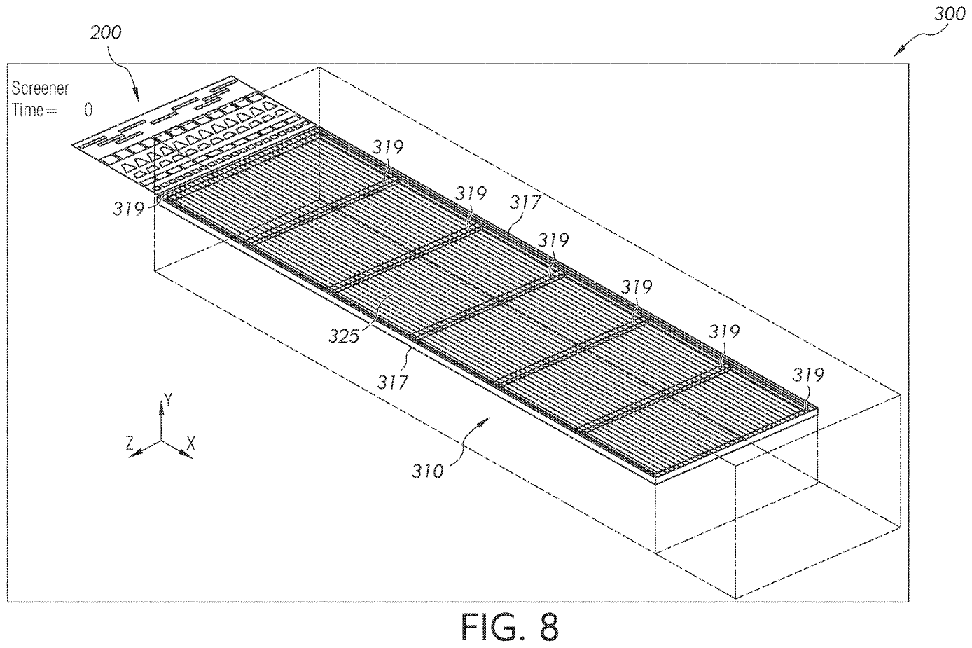

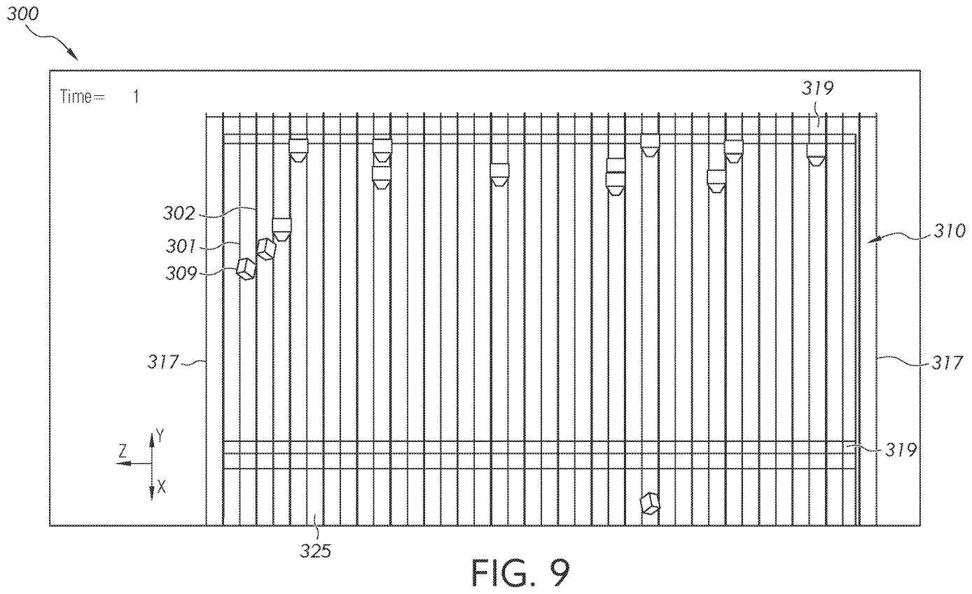

In FIG. 8, an overview of a unidirectional screen system 300 is schematically depicted that includes a unidirectional screen 310. The unidirectional screen 310 includes a screen frame comprising a pair of opposing latitudinal edges 319 and a pair of opposing longitudinal edges 317, wherein the pair of opposing latitudinal edges 319 and the pair of opposing longitudinal edges 317 define a horizontal plane. The unidirectional screen 310 comprises a plurality of wires 325 extending horizontally between the pair of opposing longitudinal edges 317, wherein the wires 325 comprise straight wires (e.g, there is no curvature in the vertical direction). Various Polyethylene particles 200 are also depicted at time equals zero. Referring to the top view unidirectional screen of FIG. 9, various Polyethylene particles 200 are depicted at time equals 1.62 seconds at points further down along the opposing longitudinal edges 317. In this example, there is a first wire 301 and second wire 302, and particle 309 is blinded between them.

The particle had dimensions two times the size of Comparative Examples 1 and 2 with the 1 mm thickness. A cross-wire mesh screen design was evaluated, but none of the Polyethylene particles could successfully pass through the cross-wire design with a 1 mm thickness (e.g., 0% acceptance rate).

The FEA model for Comparative Example 3 utilized the same parameter data as Comparative Example 2 with an exception for the variety of thin Polyethylene particles. Table 3 below lists the various shapes and sizes of Polyethylene particles, each with a thickness of 1 mm. FIG. 5 depicts the general shape of the various Polyethylene particles with 2D examples of the Polyethylene particles listed in Table 3 may be seen. FIG. 8 depicts the blinding that occurred for various Polyethylene particles.

TABLE 3

| Particle | Size (mm) |
|---|---|
| PE1 (Square) | 40 × 40 |
| PE2 (Rectangle) | 80 × 40 |
| PE3 (Rectangle) | 80 × 80 |
| PE4 (Wedge) | 80 × 40 × 74 |
| PE4 (Wedge) | 80 × 32 × 50 |
| Long Streaks | 10 × 200 |

### Example 2

In Example 2, a WOOP screen design was evaluated for blinding and rejection of good Polyethylene particles using FEA for comparison with a unidirectional screen of Comparative Example 3. The particle had dimensions two times the size of Comparative Examples 1 and 2 with the 1 mm thickness.

The FEA models for Example 2 utilized the same parameter data as Example 1 with an exception for the variety of thin Polyethylene particles. Table 2 above lists the various shapes and sizes of Polyethylene particles, each with a thickness of 1 mm. FIG. 5 depicts the general shape of the various Polyethylene particles with 2D examples of the Polyethylene particles listed in Table 2 may be seen. FIG. 1 depicts an embodiment applicable to Example 2 within the WOOP screen system 110.

### Comparison of Comparative Example 3 and Example 2

Comparative Example 3 and Example 2 will now be compared for both the tendency of blinding to occur with various sized Polyethylene particles in addition to the rejection rate of the Polyethylene particles. Table 4 below shows the number of Polyethylene particles accepted and the number of Polyethylene particles rejected for each iteration run by the FEA model for both the unidirectional screen and the WOOP screen systems.

TABLE 4

| Particle Size, (mm × | Comparative Example 3 | | Example 2 (WOOP | |
|---|---|---|---|---|
| mm) | (Unidirectional Screen) | | Screen) | |
| Thickness = 1 mm | Accept | Reject | Accept | Reject |
| PE1 - 40 × 40 | 22 | 1 | 18 | 5 |
| PE2 - 80 × 40 | 3 | 9 | 11 | 1 |
| PE3 - 80 × 80 | 0 | 12 | 0 | 12 |
| PE4 - 80 × 40 × 74 | 1 | 11 | 5 | 7 |
| PE5 - 80 × 32 × 50 | 0 | 12 | 11 | 1 |
| Long Streaks | 0 | 12 | 0 | 12 |
| Total | 26 | 57 | 45 | 38 |

| | | |
|---|---|---|
| Blinded Particles | 0 | 0 |
| Acceptance Efficiency | 26/83 = 31.3% | 45/83 = 54.2% |

As seen in Table 4 above, the unidirectional screen system of Comparative Example 3 had a 31.3% acceptance rate after all iterations of the FEA model were run, for a total of 72 example particles. However, the WOOP screen system of Example 2 showed an acceptance rate of 54.2% with the same number of particles of the same shape. Neither the unidirectional nor the WOOP screen systems experienced any blinding.

### Comparative Example 4

In another case of Comparative Example 4, Polyethylene particles with a thickness of 30 mm were analyzed in a unidirectional screen design. FIG. 9 shows the unidirectional screen system 300 from an above view after 1.62 seconds have passed. Blinding can be seen in the unidirectional screen system 300 with various Polyethylene particles 200. For example, between a first wire 301 and second wire 302, particle 309 is blinded.

The FEA models for Comparative Example 4 utilized the same parameter data as Comparative Examples 2 and 3 with an exception for the variety of thin Polyethylene particles. The FEA model for Comparative Example 4 utilized polyethylene particles with a 30 mm thickness, and shell elements and particles having 30 mm thickness were modelled with solid elements instead of shell elements. Additionally, these polyethylene particles were provided with very small vertical downward velocity (e.g., 10 mm/s) and no initial horizontal velocity. This was done to avoid the tendency of solid particles to bounce and fly around when the solid particles hit the steel wires. The solid particles that still fly around are contained within the machine space by the container walls. Additionally, no platform was utilized to position the solid polyethylene particles; the solid polyethylene particles were directly positioned on the screen.

### Example 3

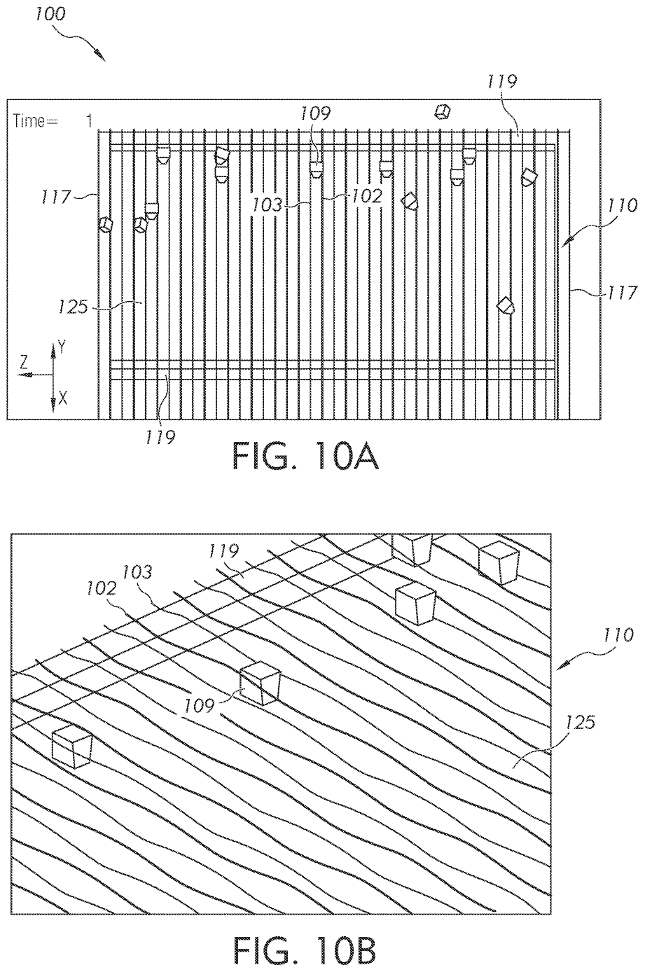

As in Comparative Example 4, Example 3 analyzed Polyethylene particles with a 30 mm thickness. This example utilized the WOOP screen system. FIG. 10A shows the unidirectional screen system 300 from an above view after 1.62 seconds have passed. As depicted in FIG. 10A, fewer Polyethylene particles are blinded than Comparative Example 3 in FIG. 9. FIG. 10B shows the blinding that can be seen within the plurality of wires 125 with wavy profiles. For example, between a first wire 102 and second wire 103, particle 109 is blinded.

The FEA models for Example 3 utilized the same parameter data as Comparative Example 4, with an exception for the change in screen geometry. Table 5 below lists the various shapes and sizes of Polyethylene particles, each with a thickness of 30 mm. FIG. 1 depicts an embodiment applicable to Example 3 within the WOOP screen system 110.

### Comparison of Comparative Example 4 to Example 3

Comparative Example 4 and Example 3 will now be compared for both the tendency of blinding to occur with various sized Polyethylene particles in addition to the rejection rate of the Polyethylene particles. Table 5 below shows the number of Polyethylene particles accepted and the number of Polyethylene particles rejected for each iteration run by the FEA model for both the unidirectional screen and the WOOP screen systems.

TABLE 5

| Particle Size, | Comparative Example 4 | | | Example 3 | |
|---|---|---|---|---|---|
| (mm × mm × | (Unidirectional Screen) | | | (WOOP Screen) | |
| Thickness = 30 | Accept | Reject | | Accept | Reject |
| 7.7 × 13.8 × 15.5 | 11 | 0 | | 11 | 0 |
| 7.7 × 17 × 15.5 | 11 | 0 | | 11 | 0 |
| 7.7 × 20 × 15.5 | 12 | 0 | | 12 | 0 |
| 15.4 × 21.5 × | 9 | 2 | | 8 | 3 |
| 15.5 | | | | | |
| 15.4 × 27.7 × 31 | 3 | 8 | (1 -blinded) | 5 | 6 |
| 15.4 × 27.7 × 31 | 0 | 11 | (7- | 0 | 11 (6- blinded) |
| 15.4 × 33.8 × 31 | 0 | 11 | (3- | 0 | 11 (3-blinded) |

| | | | | |
|---|---|---|---|---|
| 15.4 × 40 × 31 | 0 | 11 | 0 | 11 |
| Total | 46 | 43 | 47 | 42 |

| | | |
|---|---|---|
| Blinded Particles | 11 | 9 |
| Acceptance | 46/89 = 51.7% | 47/89 = 52.8% |

As seen in Table 5 above, the unidirectional screen system of Comparative Example 4 had a 51.7% acceptance rate after all iterations of the FEA model were run, for a total of 89 example particles. The WOOP screen system of Example 3 showed an acceptance rate of 52.8% with the same number of particles of the same shape. The unidirectional screen system of Comparative Example 4 experienced blinding with 11 particles clogging the screen. The WOOP screen system of Example 3 also experienced blinding, with 9 particles clogging the screen.

### Analysis of Geometries of the WOOP Screen

Further geometries of the WOOP screen were analyzed along with various Polyethylene particles. Table 6 below illustrates various geometries by indicating the value for the amplitude with an absolute value of H and a period of 2 A. FIG. 1 depicts an embodiment applicable to these examples within the WOOP screen system 110.

TABLE 6

| Geometry | H value | A value |
|---|---|---|
| 1 | 7 mm | 100 mm |
| 2 | 5 mm | 100 mm |
| 3 | 10 mm | 100 mm |
| 4 | 7 mm | 50 mm |
| 5 | 7 mm | 150 mm |

The effect of WOOP screen wire geometry on the acceptance efficiency for Polyethylene particles with a thickness of 1 mm can be seen from Table 7 below. The acceptance efficiency for WOOP screen systems depicted in Table 7 ranges from 49.4% to 62.6% while the unidirectional screen system of Comparative Example 3 had acceptance efficiency of 31.3%. No blinding occurred in either system.

TABLE 7

| Particle Size | Geometry 1 | | Geometry 2 | | Geometry 3 | | Geometry 4 | | Geometry 5 | |
|---|---|---|---|---|---|---|---|---|---|---|
| Thickness = 1 mm | Accept | Reject | Accept | Reject | Accept | Reject | Accept | Reject | Accept | Reject |
| PE1 | 18 | 5 | 19 | 4 | 20 | 3 | 21 | 2 | 21 | 2 |
| PE2 | 11 | 1 | 9 | 3 | 9 | 3 | 9 | 3 | 11 | 1 |
| PE3 | 0 | 12 | 3 | 9 | 0 | 12 | 2 | 10 | 7 | 5 |
| PE4 | 5 | 7 | 7 | 5 | 3 | 9 | 3 | 9 | 7 | 5 |
| PE5 | 11 | 1 | 11 | 1 | 9 | 3 | 9 | 3 | 6 | 6 |
| Long Streaks | 0 | 12 | 0 | 12 | 0 | 12 | 4 | 8 | 0 | 12 |
| Total | 45 | 38 | 49 | 34 | 41 | 42 | 48 | 35 | 52 | 31 |

| | | | | | |
|---|---|---|---|---|---|
| Blinded Particles | 0 | 0 | 0 | 0 | 0 |
| Acceptance Efficiency | 54.2% | 59% | 49.4% | 57.8% | 62.6% |

The analysis of various geometries of the WOOP screen system is continued in Table 8 below with Polyethylene particles having a thickness of 30 mm. The acceptance efficiency for WOOP screen systems depicted in Table 8 ranges from 48.3% to 53.9% while the unidirectional screen system of Comparative Example 4 had acceptance efficiency of 51.7%. With the 30 mm thickness of the Polyethylene particles, blinding occurred in the range of 9 to 11 particles out of a total of 89. In Comparative Example 4, blinding occurred for 11 particles out of 89.

TABLE 8

| Particle Size | Geometry 1 | | Geometry 2 | | Geometry 3 | | Geometry 4 | | Geometry 5 | |
|---|---|---|---|---|---|---|---|---|---|---|
| Thickness = 30 mm | Accept | Reject | Accept | Reject | Accept | Reject | Accept | Reject | Accept | Reject |
| 7.7 × 13.8 × 15.5 | 11 | 0 | 11 | 0 | 11 | 0 | 11 | 0 | 10 | 1 |
| 7.7 × 17 × 15.5 | 11 | 0 | 11 | 0 | 11 | 0 | 11 | 0 | 11 | 0 |
| 7.7 × 20 × 15.5 | 12 | 0 | 11 | 1 | 11 | 1 | 10 | 2 | 11 | 1 |
| 15.4 × 21.5 × 15.5 | 8 | 3 | 8 | 3 | 11 | 0 | 11 | 0 | 11 | 0 |
| 15.4 × 21.5 × 31 | 5 | 6 | 1 | 10 | 4 | 7 | 2 | 9 | 4 | 7 |
| 15.4 × 27.7 × 31 | 0 | 11 (6- | 0 | 11 (7- | 0 | 11 (8 - | 0 | 11 (6- | 0 | 11 (6- |
| | | blinded) | | blinded) | | blinded) | | blinded) | | blinded) |
| 15.4 × 33.8 × 31 | 0 | 11 (3- | 0 | 11 (3- | 0 | 11 (3- | 0 | 11 (1- | 0 | 11 (3- |
| | | blinded) | | blinded) | | blinded) | | blinded) | | blinded) |
| 15.4 × 40 × 31 | 0 | 11 | 0 | 11 | 0 | 11 | 0 | 11 | 0 | 11 |
| Total | 47 | 42 | 43 | 46 | 48 | 41 | 45 | 44 | 47 | 42 |

| | | | | | |
|---|---|---|---|---|---|
| Blinded Particles | 9 | 10 | 11 | 7 | 9 |
| Acceptance Efficiency | 47/89 = 52.8% | 43/89=48.3% | 48/89=53.9% | 45/89=50.6% | 47/89=52.8% |

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Directional terms as used herein—for example up, down, right, left, front, back, top, bottom—are made only with reference to the figures as drawn and are not intended to imply absolute orientation unless otherwise specified.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any device or assembly claim does not actually recite an order or orientation to individual components, or it is not otherwise specifically stated in the claims or description that the steps are to be limited to a specific order, or that a specific order or orientation to components of an device or assembly is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an,” and “the” include plural referents unless the context clearly dictates otherwise. Thus, for example, reference to “a” component includes aspects having two or more such components, unless the context clearly indicates otherwise.

It should be understood that any two quantitative values assigned to a property may constitute a range of that property, and all combinations of ranges formed from all stated quantitative values of a given property are contemplated in this disclosure.

It should be apparent to those skilled in the art that various modifications can be made to the described embodiments without departing from the spirit and scope of the claimed subject matter. Thus, it is intended that the specification cover modifications and variations of the described embodiments provided such modification and variations come within the scope of the appended claims and their equivalents.

1. A screen comprising:
a screen frame comprising a pair of opposing latitudinal edges and a pair of opposing longitudinal edges, wherein the pair of opposing latitudinal edges and the pair of opposing longitudinal edges define a horizontal plane;
a plurality of wires extending horizontally between the pair of opposing longitudinal edges, wherein the wires comprise wavy vertical profiles relative to the horizontal plane, and wherein adjacent wires have differing wavy vertical profiles.

2. The screen of claim 1, wherein the screen does not include crosswires extending horizontally between the pair of opposing latitudinal edges.

3. The screen of claim 1, wherein the plurality of wires comprise stainless steel.

4. The screen of claim 1, wherein horizontal spacing between adjacent wires is uniform.

5. The screen of claim 1, wherein the wavy vertical profiles comprise a sinusoidal profile, and wherein adjacent wires are out of phase.

6. A vibratory particle screener comprising the screen of claim 1.

7. The vibratory particle screener of claim 6, wherein the screen is oriented at an angle.

8. The vibratory particle screener of claim 6, wherein the vibratory particle screener includes a housing comprising at least one accept bin and at least one reject bin, wherein the accept bin is oriented to receive particles that pass through the screen and the reject bin is oriented to receive particles filtered out by the screen.

9. A method of filtering out off-spec material from a particle mixture using the vibratory particle screener of claim 6, wherein the off-spec material are larger particles blocked by the screen.

10. The method of claim 9, wherein the particle mixture comprises polyolefin particles selected from polyethylene or polypropylene.
